(19) United States
(12) Patent Application Publication
(10) Pub. No.: US 2013/0200728 A1
(43) Pub. Date: Aug. 8, 2013

(54) POWER MANAGEMENT SYSTEM

(71) Applicants: Chin-Min Liu, New Taipei City (TW); Chien-Fu Liao, New Taipei City (TW)

(72) Inventors: Chin-Min Liu, New Taipei City (TW); Chien-Fu Liao, New Taipei City (TW)

(21) Appl. No.: 13/440,968

(22) Filed: Apr. 5, 2012

(30) Foreign Application Priority Data
Feb. 2, 2012 (TW) 101103350

(51) Int. Cl. H01H 47/00

(52) U.S. Cl. 307/130

(57) ABSTRACT

A power management system for an electronic device includes a first power converting module, for selectively converting an input voltage of a battery module of the electronic device to a first supply voltage and outputting the first supply voltage to an output node according to a first control signal; a second power converting module, for selectively converting the input voltage to a second supply voltage and outputting the second supply voltage to the output node according to a second control signal; and a logic control module, for outputting the first control signal and the second control signal according to the input voltage and a threshold voltage in order to control whether the input voltage is converted by the first power converting module or the second power converting module.

### BACKGROUND OF THE INVENTION

1. Field of the Invention

The present invention relates to a power management system, and more particularly, to a power management system capable of switching different power converting modules to generate supply voltage according to a battery voltage of an electronic device.

2. Description of the Prior Art

With the advance of portable electronic devices such as mobile communication devices, notebooks and electronic books, more and more functions are being integrated in the portable electronic devices. Including essential functions (e.g. communication function of the mobile communication devices, document processing function of the notebooks and reading function of the electronic books), the portable electronic devices further have secondary functions such as game functions, multimedia playback functions and navigation functions. Power consumption of these portable electronic devices is therefore becoming significant.

A portable electronic device uses a battery as a power source for ease of portability. Since an input voltage provided by the battery to the portable electronic device is greater than an operation voltage of the portable electronic device, the portable electronic device needs a buck power converter to convert the input voltage to the operation voltage. In addition, the input voltage decreases with the power of the battery. When the input voltage decreases to a threshold voltage, the buck converter will not work normally which means the portable electronic device will be inoperable. The remaining power of the battery is still sufficient for the portable electronic device to work, however. Thus, if the remaining power of the battery can be used, the battery life of the portable electronic device can be effectively prolonged.

In conventional technologies, the portable electronic device can use a buck-boost power converter to prolong the battery life. Buck-boost power converters are expensive and complex, however, which will result in raising the manufacturing cost of the portable electronic device. Therefore, how to use a low-cost power converter to effectively prolong battery life of a portable device is a goal of the industry.

### SUMMARY OF THE INVENTION

The present invention provides a power management system for switching different power converting modules to convert supply voltage when the input voltage provided by the battery of an electronic device is lower than a threshold voltage.

An embodiment of the invention discloses a power management system for an electronic device. The power management system comprises a first power converting module, for selectively converting an input voltage of a battery module of the electronic device to a first supply voltage and outputting the first supply voltage to an output node according to a first control signal; a second power converting module, for selectively converting the input voltage to a second supply voltage and outputting the second supply voltage to the output node according to a second control signal; and a logic control module, for outputting the first control signal and the second control signal according to the input voltage and a threshold voltage in order to control whether the input voltage is converted by the first power converting module or the second power converting module.

An embodiment of the invention further discloses a power management system for an electronic device. The power management system comprises a power-stage module, for converting an input voltage of a battery module of the electronic device to a supply voltage and outputting the supply voltage to an output node according to a first power driving signal and a second power driving signal; a power driving module, coupled to the power-stage module, comprising: a first power driving unit, for selectively outputting the first power driving signal and the second power driving signal according to a control signal; a second power driving unit, for selectively outputting the second power driving signal and the second power driving signal according to the control signal; and a logic control module, coupled to the power driving module for outputting the control signal according to the input voltage and a threshold voltage in order to control whether the first power driving signal and the second power driving signal are outputted by the first power driving unit or the second power driving unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power management system according to an embodiment of the invention.

FIG. 2 is a schematic diagram of an implementation of the power management system shown in FIG. 1.

FIG. 3 is a schematic diagram of related signals when the power management system shown in FIG. 2 operates.

FIG. 4 is a schematic diagram of another implementation of the power management system shown in FIG. 1.

FIG. 5 is a schematic diagram of related signals when the power management system shown in FIG. 4 operates.

FIG. 6 is a schematic diagram of another implementation method of the power management system shown in FIG. 1.

FIG. 7 is a schematic diagram of a power management system according to an embodiment of the invention.

### DETAILED DESCRIPTION

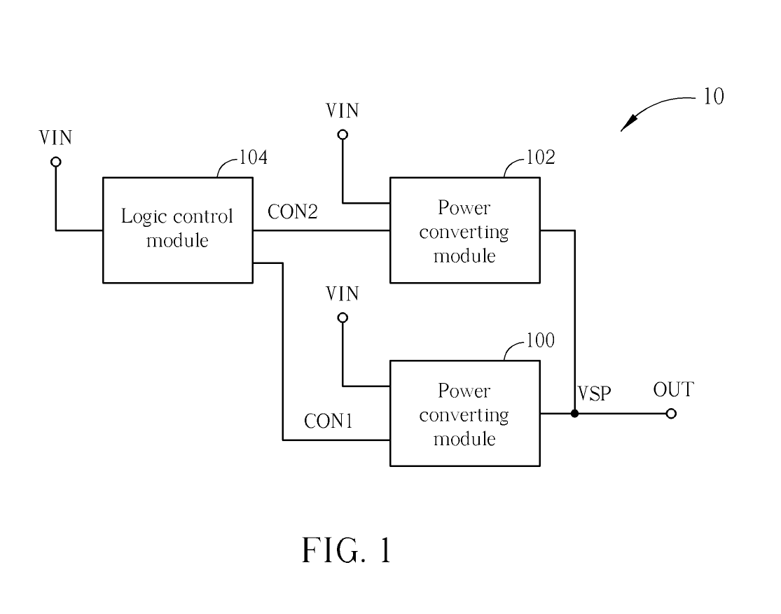

Please refer to FIG. 1, which is a schematic diagram of a power management system 10 according to an embodiment of the invention. The power management system 10 is utilized in an electronic device for converting an input voltage VIN provided by a battery module (not shown in FIG. 1) of the electronic device to a lower supply voltage VSP and outputting the supply voltage VSP to an output node OUT. As shown in FIG. 1, the power management system 10 comprises power converting modules 100, 102 and a logic control module 104. The power converting module 100 is utilized for selectively converting the input voltage VIN to the supply voltage VSP according to a control signal CON1, wherein the power converting module 100 can effectively convert the input voltage VIN to the supply voltage VSP when the input voltage VIN is greater than a threshold voltage VTH. The power converting module 100 may be a buck power converter, but is not limited thereto. The power converting module 102 is utilized for selectively converting the input voltage VIN to the supply voltage VSP according to a control signal CON2, wherein the power converting module 102 can effectively convert the input voltage VIN to the supply voltage VSP when the input voltage VIN is smaller than the threshold voltage VTH. The power converting module 102 may be a low-dropout regulator, but is not limited thereto. The logic control module 104 is utilized for adjusting the control signals CON1, CON2 to instruct the power converting module 100 to start operating and instruct the power converting module 102 to stop operating when the input voltage VIN is greater than the threshold voltage VTH. In such a condition, the supply voltage VSP is generated by the power converting module 100. The logic control module 104 adjusts the control signals CON1, CON2 to instruct the power converting module 100 to stop operating and the power converting module 102 to start operating when the input voltage VIN is smaller than the threshold voltage VTH. In such a condition, the supply voltage VSP is generated by the power converting module 102.

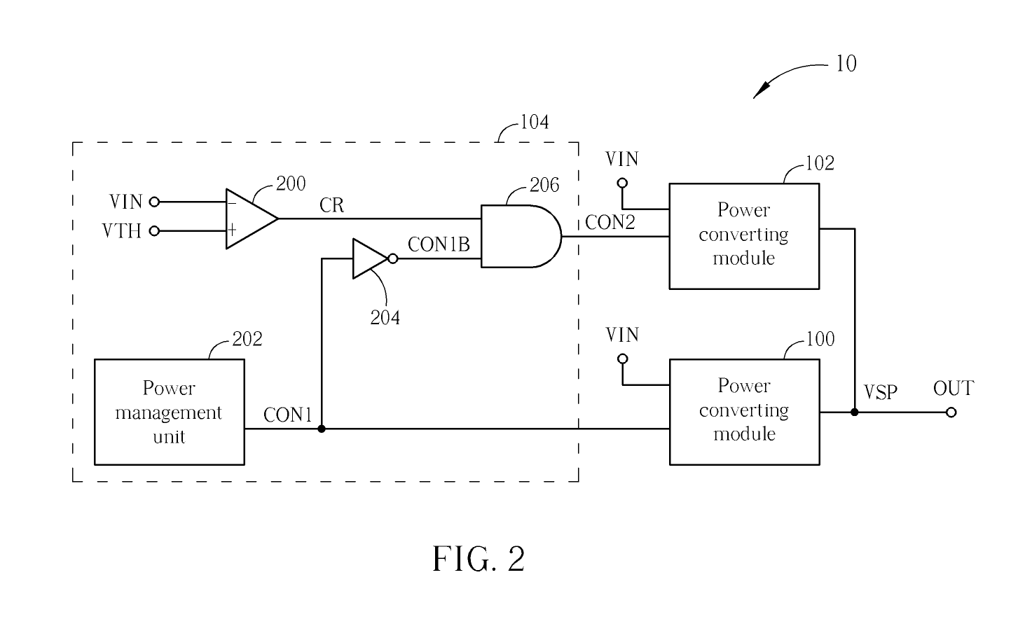

Noticeably, the power management system 10 is one embodiment of the present invention and is illustrated by a block diagram. The implementation methods of each block and generating methods of related signals can be appropriately modified according to various system requirements. For example, please refer to FIG. 2, which is a schematic diagram of an implementation of the logic control module 104 of the power management system 10. As shown in FIG. 2, the logic control module 104 comprises a comparison unit 200, a power management unit 202, an inverter 204 and an AND gate 206. The comparison unit 200 is utilized for comparing the input voltage VIN and the threshold voltage VTH and accordingly outputting a comparison result CR. Similarly, the power management unit 202 is utilized for outputting the corresponding control signal CON1 according to the input voltage VIN and the threshold voltage VTH, to instruct the power converting module 100 to selectively convert the input voltage VIN to the supply voltage VSP when the input voltage is greater than the threshold voltage VTH. The inverter 204 is utilized for receiving the control signal CON and generating a reverse signal CON1B. The AND gate 206 is utilized for receiving the reverse signal CON1B and the comparison result CR and accordingly outputting the control signal CON2, to instruct the power converting module 102 to selectively convert the input voltage VIN to the supply voltage VSP when the input voltage VIN is smaller than the threshold voltage VTH.

Via the logic control module 104, the power management unit 202 outputs the control signal CON1 in high logic voltage when the input voltage VIN is greater than the threshold voltage VTH, to instruct the power converting module 100 to start operating. In such a condition, the input voltage VIN is converted to the supply voltage VSP by the power converting module 100. At the same time, the comparison unit 200 outputs the comparison result CR in low logic voltage and the AND gate 206 generates the control signal CON2 in low logic voltage according to the comparison result CR and the reverse signal CON1B, to instruct the power converting module 102 to stop operating. When the input voltage VIN is smaller than the threshold voltage VTH, the power management unit 202 switches the control signal CON1 to low logic voltage, to instruct the power converting module 100 to stop operating. At the same time, the AND gates 206 outputs the control signal CON2 in high logic voltage according to the comparison result CR and the reverse signal CON1B, to instruct the power converting module 102 to start operating. In such a condition, the input voltage VIN is converted to the supply voltage VSP by the power converting module 102.

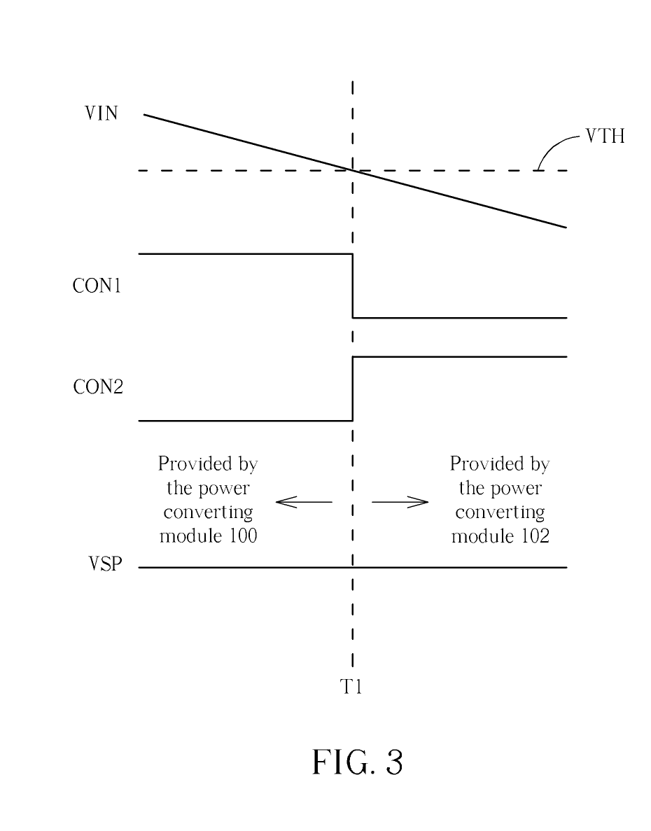

Please refer to FIG. 3, which is a schematic diagram of related signals when the power management system 10 shown in FIG. 2 is operating. As shown in FIG. 3, before a time T1, the input signal VIN is greater than the threshold voltage VTH. Thus, the control signal CON1 is in high logic voltage, the comparison result CR is in low logic voltage and the control signal CON2 is in low logic voltage. In such a condition, the supply voltage VSP is generated by the power converting module 100. After the time T1, the input voltage VIN is smaller than the threshold voltage VTH. Therefore, the control signal CON1 is switched to low logic voltage, the comparison result CR is switched to high logic voltage and the control signal CON2 is switched to high logic voltage. In such a condition, the supply voltage VSP is generated by the power converting module 102.

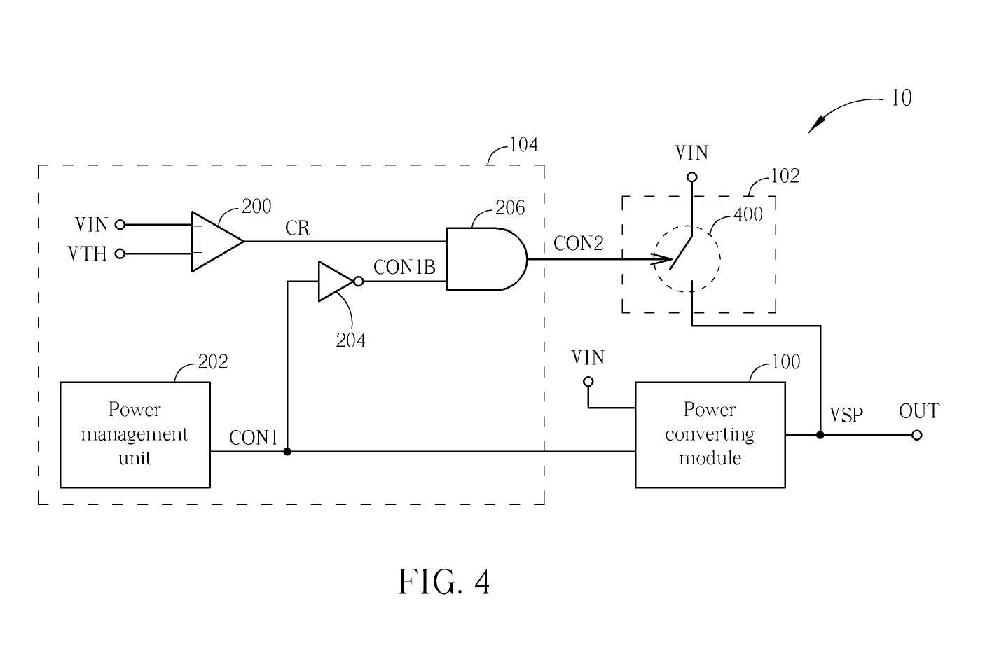

A tolerable voltage range of supply voltage VSP is within a maximum supply voltage VSP_MAX and a minimum supply voltage VSP_MIN. Therefore, if the threshold voltage VTH is set to the maximum supply voltage VSP_MAX, the supply voltage VSP can be directly provided by the input voltage VIN when the input voltage VIN is smaller than the threshold voltage VTH (i.e. the maximum supply voltage VSP_MAX). Please refer to FIG. 4, which is a schematic diagram of another implementation of the power management system 10 shown in FIG. 1. Architecture of the power management system 10 shown in FIG. 4 is similar to that of the power management system 10 shown in FIG. 2. However, a difference between the power management system 10 shown in FIG. 4 and the power management system 10 shown in FIG. 2 is that the power converting module 102 of the power management system 10 shown in FIG. 4 is implemented by a switch 400. The switch 400 is utilized for controlling a connection between the input voltage VIN and the output node OUT according to the control signal CON2. In detail, when the input voltage VIN is greater than the threshold voltage VTH, the power management unit 202 outputs the control signal CON1 in high logic voltage to instruct the power converting module 100 to convert the input voltage VIN to the supply voltage VSP. At the same time, the comparison unit 200 outputs the comparison result CR in low logic voltage and the AND gate 206 outputs the control signal CON2 in low logic voltage according to the reverse signal CON1B and the comparison result CR to disconnect the switch 400. When the input voltage VIN is smaller than the threshold voltage VTH, the power management unit 202 switches the control signal CON1 to low logic voltage to instruct the power converting module 100 to stop operating. At the same time, the comparison unit 200 switches the comparison result CR to high logic voltage and the AND gate 206 outputs the control signal CON2 in high logic voltage to conduct the switch 400. In such a condition, the supply voltage VSP equals the input voltage VIN.

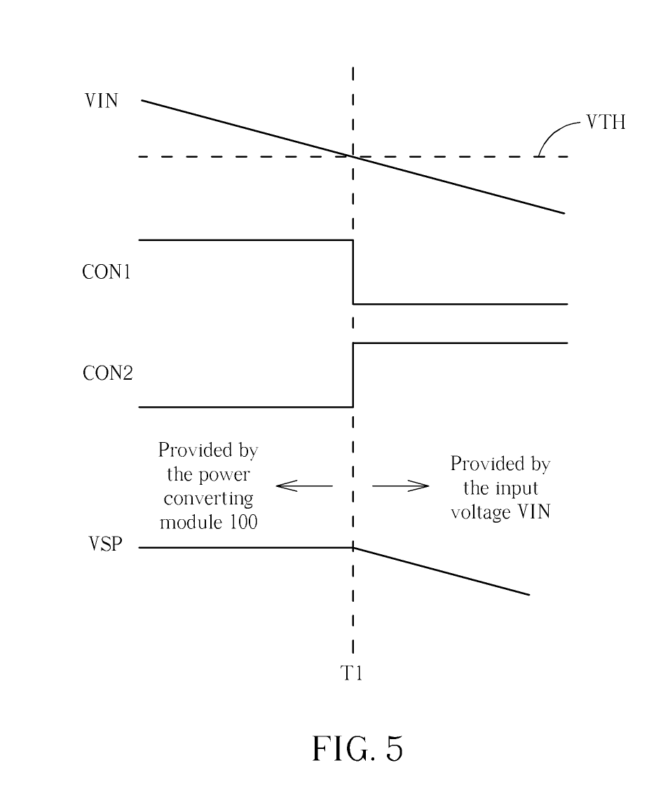

Please refer to FIG. 5, which is a schematic diagram of related signals when the power management system 10 shown in FIG. 4 is operating. As shown in FIG. 5, before the time T1, the input voltage VIN is greater than the threshold voltage VTH. Thus, the control signal CON1 is in high logic voltage, the comparison result CR is in low logic voltage and the control signal CON2 is in low logic voltage. In such a condition, the supply voltage VSP is generated by the power converting module 100. After the time T1, the input voltage VIN is smaller than the threshold voltage VTH. Therefore, the control signal CON1 is switched to low logic voltage, the comparison result CR is switched to high logic voltage and the control signal CON2 is switched to high logic voltage. In such a condition, the supply voltage VSP equals the input voltage VIN.

The main spirit of the present invention is comparing the input voltage and the threshold voltage to appropriately switch power converting modules to generate the supply voltage, such that the battery life of the electronic device can be effectively prolonged. Those skilled in the art can accordingly observe appropriate modifications and adjustments according to different applications.

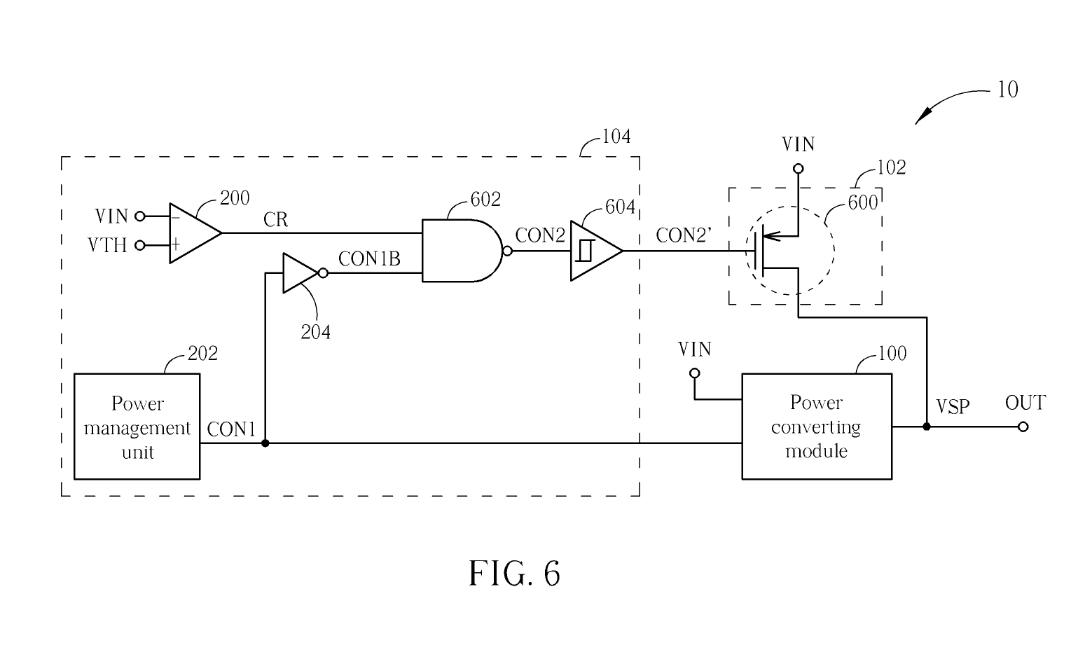

Please refer to FIG. 6, which is a schematic diagram of another implementation of the power management system 10 shown in FIG. 4. Different from the power management system 10 shown in FIG. 4, the switch 400 of the power management system 10 shown in FIG. 6 is implemented in a PMOS 600. Therefore, in order to maintain the conductive characteristic of the PMOS 600 equals the conductive characteristic of the switch 400, the AND gate 206 has to be replaced by an NAND gate 602. In addition, the logic control module 104 further comprises a Schmitt trigger 604 coupled between the logic control module 104 and the power converting module 102. The Schmitt trigger 604 is utilized for buffering the control signal CON2 and accordingly generating a control signal CON2′, to prevent the PMOS 600 from abnormally conducting or disconnecting due to noise on the control signal CON2. The detailed operations of the power management system 10 shown in FIG. 6 are similar to the power management system 10 shown in FIG. 4 and are not described herein for brevity.

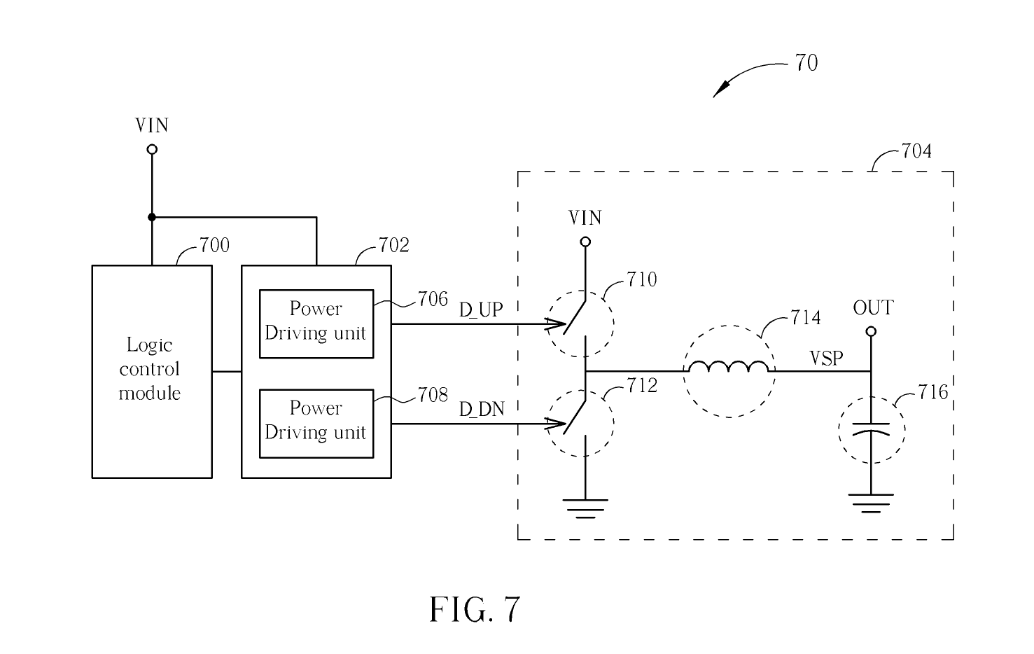

Please refer to FIG. 7, which is a schematic diagram of a power management system 70 according to an embodiment of the invention. The power management system 70 appropriately modifies the power converting module 100, 102 of the power management system 10 in order to allow different power management modules to jointly use parts of circuit components, such that the manufacturing cost of the power management system can be reduced. As shown in FIG. 7, the power management system 70 comprises a logic control module 700, a power driving module 702 and a power stage 704. The logic control module 700 is utilized for adjusting a control signal CON according to the input voltage VIN of the battery module and the threshold voltage VTH. The power driving module 702 comprises power driving units 706, 708, and is utilized for instructing whether power driving signals D_UP, D_DN are generated by the power driving unit 706 or the power driving unit 708. The power stage module 704 comprises a high-side switch 710, a low-side switch 712, an inductor 714 and a capacitor 716, and is utilized for converting the input voltage VIN to the supply voltage VSP and outputting the supply voltage VSP to the output node OUT according to the power driving signals D_UP, D_DN.

In detail, the logic control module 700 adjusts the control signal CON to instruct the power driving unit 706 to generate the power driving signals D_UP, D_DN when the input voltage VIN is greater than the threshold voltage VTH. The power driving unit 706 generates the power driving signals D_UP, D_DN according to the input voltage VIN, such that the high-side switch 710 and the low-side switch 712 are periodically conductive. In such a condition, the power driving module 702 in co-operation with the power-stage module 704 acts as a buck power converter. The operational concept of the buck power converter is well-known to those skilled in the art and is therefore not described herein for brevity. The power management system 70 converts the input voltage VIN to the supply voltage VSP as the buck power converter when the input voltage VIN is greater than the threshold voltage VTH.

The logic control module 700 adjusts the control signal CON to instruct the power driving unit 708 to generate the power driving signals D_UP, D_DN when the input voltage VIN is smaller than the threshold voltage VTH. The power driving unit 708 generates the power driving signals D_UP, D_DN according to the input voltage VIN, such that the high-side switch 710 is consistently conductive. In such a condition, the power driving module 702 in co-operation with the power-stage module 704 acts as a low-dropout regulator. The operational concept of the low-dropout regulator is well-known to those skilled in the art and is not described herein for brevity. As a result, the power management 70 converts the input voltage VIN to the supply voltage VSP as the low-dropout regulator when the input voltage VIN is smaller than the threshold voltage VTH.

To sum up, when the input voltage provided by the battery module of the electronic device is smaller than the threshold voltage, the present invention switches different power converting module or different power conversion methods to convert the input voltage to the supply voltage, such that the remaining power of the battery module can be used and the battery life of the electronic device can be prolonged. In comparison with the prior art, the present invention achieves the goal of prolonging the battery life of the electronic device with low-cost power converters.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power management system for an electronic device, comprising:
a first power converting module, for selectively converting an input voltage of a battery module of the electronic device to a first supply voltage and outputting the first supply voltage to an output node according to a first control signal;
a second power converting module, for selectively converting the input voltage to a second supply voltage and outputting the second supply voltage to the output node according to a second control signal; and
a logic control module, for outputting the first control signal and the second control signal according to the input voltage and a threshold voltage in order to control whether the input voltage is converted by the first power converting module or the second power converting module.

2. The power management system of claim 1, wherein the logic control module comprises:
a power manager, for outputting the first control signal;
a comparator, for comparing the threshold voltage and the input voltage to output a comparison result; and
a logic unit, coupled to the power manager and the comparator for outputting the second control signal according to the first control signal and the comparison result.

3. The power management system of claim 2, wherein when the comparison result shows the input voltage is greater than the threshold voltage, the power manager adjusts the first control signal to instruct the first power converting module to convert the input voltage and the logic unit adjusts the second control signal to instruct the second power converting module to stop operating.

4. The power management system of claim 2, wherein when the comparison result shows the input voltage is smaller than the threshold voltage, the power manager adjusts the first control signal to instruct the first power converting module to stop operating and the logic unit adjusts the second control signal to instruct the second power converting module to convert the input voltage.

5. The power management system of claim 1, wherein the first power converting module is a buck power converter.

6. The power management system of claim 1, wherein the second power converting module comprises a switching module coupled between the input voltage and the output node.

7. The power management system of claim 6, wherein the switching module is a P-MOS, comprising a drain coupled to the input voltage, a gate coupled to the second control signal and a source coupled to the output node.

8. The power management system of claim 6, wherein the second power converting module further comprises a Schmitt trigger between the switching module and the logic control module.

9. The power management system of claim 1, wherein the second power converting module is a low-dropout regulator.

10. A power management system, for an electronic device, comprising:
a power-stage module, for converting an input voltage of a battery module of the electronic device to a supply voltage and outputting the supply voltage to an output node according to a first power driving signal and a second power driving signal;
a power driving module, coupled to the power-stage module, comprising:
a first power driving unit, for selectively outputting the first power driving signal and the second power driving signal according to a control signal;
a second power driving unit, for selectively outputting the second power driving signal and the second power driving signal according to the control signal; and
a logic control module, coupled to the power driving module for outputting the control signal according to the input voltage and a threshold voltage in order to control whether the first power driving signal and the second power driving signal are outputted by the first power driving unit or the second power driving unit.

11. The power management system of claim 10, wherein the power-stage module comprises:
a high-side switch, coupled between the input voltage and a first node;
a low-side switch, coupled between the first node and ground;
an inductor, coupled between the first node and the output node; and
a capacitor, coupled between the output node and ground.

12. The power management system of claim 11, wherein when the input voltage is greater than the threshold voltage, the logic control module adjusts the control signal to control the first power driving unit to output the first power driving signal and the second power driving signal, so that the high-side switch and the low-side switch are periodically conductive.

13. The power management system of claim 12, wherein the power driving module in cooperation with the power-stage module acts as a buck power converter.

14. The power management system of claim 11, wherein when the input voltage is smaller than the threshold voltage, the logic control unit adjusts the control signal to control the second power driving unit to output the first power driving signal and the second power driving signal, so that the high-side switch is consistently conductive.

15. The power management system of claim 14, wherein the power driving module in cooperation with the power-stage module acts as a low-dropout regulator.
